(19) United States
(12) Patent Application Publication
(10) Pub. No.: US 2017/0352096 A1
(43) Pub. Date: Dec. 7, 2017

(54) BANK TRADE SETTLEMENT METHOD

(71) Applicant: Youjun LV, Yantai, Shandong (CN)

(72) Inventors: Youjun LV, Yantai, Shandong (CN); Jiang YU, Yantai, Shandong (CN)

(73) Assignee: Youjun LV, Yantai, Shandong (CN)

(21) Appl. No.: 15/534,480

(22) PCT Filed: Dec. 2, 2015
(86) PCT No.: PCT/CN2015/096213

§ 371 Date: Jun. 8, 2017

(30) Foreign Application Priority Data
Dec. 8, 2014 (CN) 201410742226.9

(51) Int. Cl. G06Q 40/04; G06Q 40/02; G06Q 10/08

(52) U.S. Cl. CPC G06Q 40/04; G06Q 10/0832; G06Q 40/02

(57) ABSTRACT

A bank settlement method relates to a transferable collection. Documents under a transferable collection should be controlled by the banks, until the importer makes payment against these documents (D/P). This method would avoid the possibility of the termination of the trade, when money and bank credit is insufficient on the side of the buyer and/or the trader. The seller and the buyer, the banks, the trader, all the parties can work smoothly and obtain profit which may not be obtained otherwise. Therefore, even the buyer's (including the trader's) financial strength is not strong enough, the trade can still proceed smoothly.

### CROSS REFERENCE TO RELATED APPLICATIONS

This is a national stage of PCT/CN2015/096213, which claims the priority of Chinese Application No. 201410742226.9, filed on Dec. 8, 2014. The disclosures of these prior applications are incorporated by reference in their entirety.

### BACKGROUND OF INVENTION

### Field of the Invention

This invention relates to a bank settlement method, in particular to a transferable collection, belonging to the field of trade settlements.

### Background Art

At present, relating to trade settlement, the banks provide settlement services to the clients for the funds and documents flows, which include remittance, Documents Against Payment (D/P) and Documents Against Acceptance (D/A) collection, and letters of credit.

Among the letters of credit, a transferable letter of credit is mainly provided to the buyer, the traders, and the sellers. Intermediary traders, or simply the traders, are intermediaries between the buyers and the sellers.

The three major services provided by the banks in trade settlements (remittances, D/P and D/A collections, and letters of credit) offer safe channels for the flow of funds and the flow of documents for their customers. The transferable letters of credit play a positive role for the traders to promote transactions between the sellers and the buyers.

However, in reality, if the financial strength of the buyer (including the trader) is insufficient, they will not be able to use the “letters of credit” (including transferable letters of credit) or “documents against payment (D/P),” the two main settlement services provided by the banks. The buyer's or the trader's own credit, however, is often not trusted by the seller, which often makes trade impossible. This practical problem has greatly hampered the expansions of international trades and domestic trades in countries all over the world.

### SUMMARY OF THE INVENTION

This invention provides a method of bank trade settlement for a transferable collection, in the light of the deficiencies of the existing bank settlement methods.

The technical proposals for solving the technical problems mentioned above are as follows:

A bank trade settlement method is characterized in that, before applying the method and after referring to their “transferable letter of credit” service methods and terms, the trader's bank (the collection transferring bank) prepares a “transferable collection” service method/protocol, documents such as a “Documentary collection transfer application”, etc. The method comprises the following steps:
(1) the seller delivers the goods to the shipping company;
(2) the shipping company gives the full set of bill of lading (document of title) to the seller;
(3) The seller then submits the document of title, a bank draft (money order or the same), and transferable collection instructions to the remitting bank;
(4) The remitting bank presents the transferring instructions, payment instructions, document of title, and the bank draft to the transferring bank;
(5) After receiving the documents, the transferring bank informs the intermediary trader (the trader) to submit the “Documentary collection transfer application” and the two contracts, one contract is between the trader and the buyer, and the other contract is between the trader and the seller. Then, the transferring bank requires the trader to substitute the seller's invoice and bank draft with those of the trader's own. After the substitution, the Transferring bank presents the documents to the collecting bank on behalf of the remitting bank and the trader;
(6) After receiving the documents, the collecting bank notifies the buyer to pay;
(7) After receiving the notice, the buyer can make the payment immediately or after the confirmation of the goods' arrival. After payment, the trader takes back these documents in order to take delivery of goods from the shipping company
(8) After receiving the payment from the buyer, the collecting bank makes payment to the transferring bank;
(9) After receiving the payment, and according to the “Documentary collection transfer application,” the transferable collection instructions from the remitting bank, as well as the invoices from both the seller and the trader, the transferring bank should pay to the remitting bank with the amount of the invoice from the seller, the margin between the invoices from the seller and the trader, is the profit for the trader, which should be paid by the transferring bank to the trader.
(10) After receiving the payment from the transferring bank, the remitting bank will make payment to the seller.

The advantages of the invention may include one or more of the following: avoiding trade termination when the buyer and the trader have insufficient resources and bank credit, and allowing banks, sellers, buyers, and traders to successfully and quickly realize the profits which is impossible obtained without this invention;

This method can also be used by the buyer (including the trader), even when thy have sufficient resources or funds, to reduce the opportunity cost of the funds and to make its financial performance better, which may be very important to them.

This invention may effectively promote the development of international and domestic trades, is a good way to promote the economic development of countries in the global economy, not only banks and buyers and sellers, traders can obtain obvious economic benefits, but also the social benefit.

### BRIEF DESCRIPTION OF DRAWINGS

FIG. 1 is a flow chart of this invention;

FIG. 2 is a flow chart of the existing collection workflow.

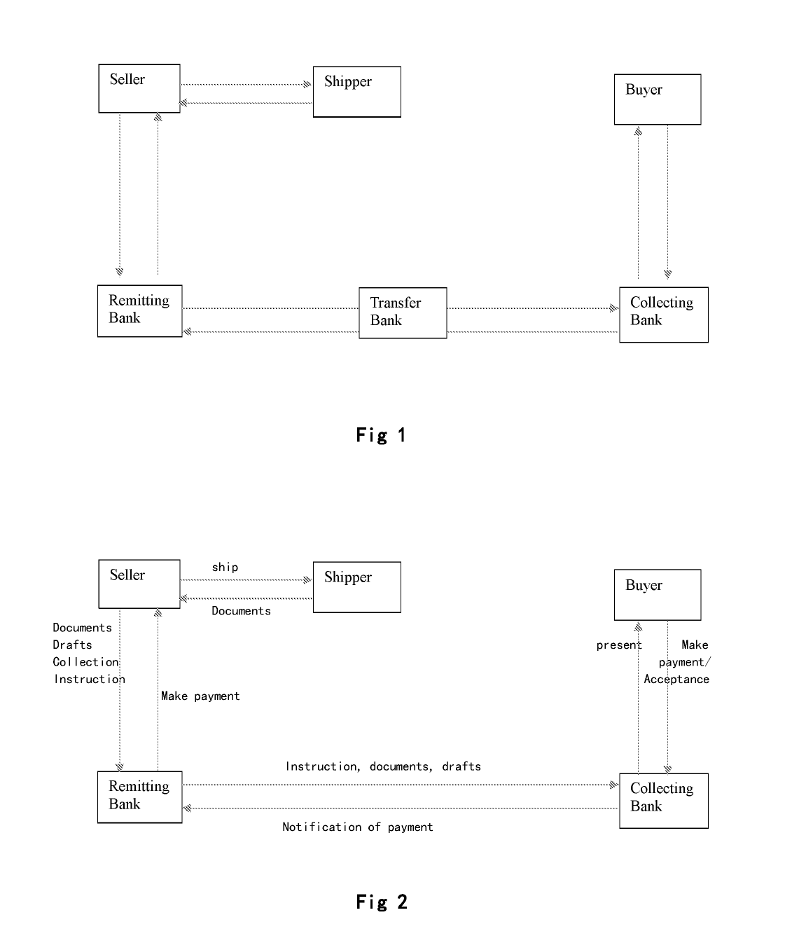

### DETAILED DESCRIPTION

The principles and features of the present invention are described below in conjunction with the drawings, and the examples are used only to interpret this invention and are not intended to qualify the scope of the invention.

A bank trade settlement method is characterized in that, before applying the method and after referring to their “transferable letter of credit” service methods and terms, the trader's bank (the collection transferring bank) prepares a “transferable collection” service method/protocol, documents such as a “Documentary collection transfer application”, etc. The method comprises the following steps:
(1) the seller delivers the goods to the shipping company;
(2) the shipping company gives the full set of bill of lading (document of title) to the seller;
(3) The seller then submits the document of title, a bank draft (money order or the same), and transferable collection instructions to the remitting bank;
(4) The remitting bank presents the transferring instructions, payment instructions, document of title, and the bank draft to the transferring bank;
(5) After receiving the documents, the transferring bank informs the intermediary trader (the trader) to submit the “Documentary collection transfer application” and the two contracts, one contract is between the trader and the buyer, and the other contract is between the trader and the seller. Then, the transferring bank requires the trader to substitute the seller's invoice and bank draft with those of the trader's own. After the substitution, the Transferring bank presents the documents to the collecting bank on behalf of the remitting bank and the trader;
(6) After receiving the documents, the collecting bank notifies the buyer to pay;
(7) After receiving the notice, the buyer can make the payment immediately or after the confirmation of the goods' arrival. After payment, the trader takes back these documents in order to take delivery of goods from the shipping company
(8) After receiving the payment from the buyer, the collecting bank makes payment to the transferring bank;
(9) After receiving the payment, and according to the “Documentary collection transfer application,” the transferable collection instructions from the remitting bank, as well as the invoices from both the seller and the trader, the transferring bank should pay to the remitting bank with the amount of the invoice from the seller, the margin between the invoices from the seller and the trader, is the profit for the trader, which should be paid by the transferring bank to the trader.
(10) After receiving the payment from the transferring bank, the remitting bank will make payment to the seller.

Using Bank of Communications, Yantai branch, as an example of the collection transferring bank:

A, when a trader comes to the transferring bank in order to substitute the documents (invoice and/or drafts), he needs to fill in the documentary collection application for transfer, and submit two-way contracts (that is, one contract between the trader and the seller, and the other one between the trader and the buyer).

In the contract between the trader and the seller, and in the cover letter of the remitting bank, shall indicate:
\textcircled{1} All interested parties agree that the Bank of Communications Yantai branch, is the transferring bank of the seller's documents;
\textcircled{2} Except the drafts (if any, and the same as the following) and invoices, all other documents cannot reveal the unit price and the total price of the goods;
\textcircled{3} The trader has the right to substitute the seller's documents, only the unit price and invoice amount can be increased, and the insurance ratio can be reduced;
\textcircled{4} The transferring bank makes payment only after it receives the payment from the buyer's bank;
\textcircled{5} If the trader refuses to substitute the seller's documents, the transferring bank has the right to send the documents directly to the buyer's bank;
\textcircled{6} The buyer cannot request the collecting bank to transfer the documents again;
\textcircled{7} The cost: each party assumes its respective bank charges. And so forth.

B, for a single trader after their substitution of documents, transferring bank (such as the Yantai branch of Bank of Communications) presents documents to the buyer's bank, and inform the seller's bank that the documents have been sent to the buyer's bank, stating that “The transferring bank will make payment only after its receiving the payment from the buyer's bank”.

The whole process is similar to transferable letter of credit. Thus, the accounting system of the trader's bank (such as Bank of communications, Yantai branch) can set up their accounting system in accordance with their mode of operation of the transferred letter of credit, in which, the trader's profit may be paid to the trader automatically by the system, and the balance to the remitting bank also.

The above is only a preferred embodiment (example) of the invention, and is not intended to limit the scope of the invention. Any modification, equivalent replacement, improvement, should be within the scope of the invention.

What is claimed is:

1. A bank trade settlement method, wherein the method comprises preparing a transferable collection service protocol by a trader's bank or a collection transferring bank, by referring to a transferable letter of credit service method, the method further comprising:
(1) delivering goods to a shipping company by a seller;
(2) providing a bill of lading from the shipping company to the seller, wherein the bill of lading is a document of title;
(3) submitting by the seller to a remitting bank the document of title, a bank draft, and transferable collection instructions;
(4) presenting by the remitting bank to a transferring bank the transferring instructions and payment instructions, the document of title, and the bank draft;
(5) informing a trader, by the transferring bank, to submit a documentary collection transfer application and two contracts, wherein the two contracts comprise one contract is between the trader and a buyer, and the other contract is between the trader and the seller; requiring, by the transferring bank, the trader to substitute a seller's invoice and the bank draft with a trader invoice and a trader bank draft; and after the substitution, presenting the trader invoice and the trader bank draft, by the transferring bank to a collecting bank on behalf of a remitting bank and the trader;
(6) after receiving the trader invoice and the trader bank draft, notifying the buyer to pay by the collecting bank;
(7) making a payment by the buyer; and after receiving the payment, taking delivery of the goods from the shipping company by the trader;
(8) making payment by the collecting bank to the transferring bank after receiving the payment from the buyer;
(9) after receiving the payment, paying by the transferring bank to the remitting bank an amount of the invoice from the seller, according to the documentary collection transfer application, the transferable collection instructions from the remitting bank, as well as the invoices from both the seller and the trader, wherein a margin between the invoices from the seller and the trader is a profit for the trader and should be paid by the transferring bank to the trader; and
(10) making payment by the remitting bank to the seller after receiving the payment from the transferring bank.
